(19) United States
(12) Patent Application Publication
(10) Pub. No.: US 2016/0115914 A1
(43) Pub. Date: Apr. 28, 2016

(54) APPARATUS FOR INPOURING EXHAUST GAS BY EXHAUST GAS RECIRCULATION

(71) Applicant: HYUNDAI MOTOR COMPANY, Seoul (KR)

(72) Inventor: Myung Soo PARK, Suwon-si (KR)

(21) Appl. No.: 14/664,635

(22) Filed: Mar. 20, 2015

(30) Foreign Application Priority Data
Oct. 28, 2014 (KR) 10-2014-0146995

(51) Int. Cl. F02M 26/35; F02D 41/00

(52) U.S. Cl. CPC F02M 26/35; F02D 41/0047

(57) ABSTRACT

An apparatus for inpouring exhaust gas by exhaust gas recirculation (EGR) including an EGR line inclined upward, into which the exhaust gas is inpoured, and having a portion of an end thereof connected to a middle portion of the exhaust line.

### CROSS REFERENCE TO RELATED APPLICATION

The present application claims the benefit of priority to Korean Patent Application No. 10-2014-0146995, filed Oct. 28, 2014, the entire contents of which is incorporated herein for all purposes by this reference.

### TECHNICAL FIELD

The present disclosure relates to an exhaust gas recirculation (EGR) system, and more particularly, to an apparatus for inpouring exhaust gas by EGR capable of preventing a catalyst powder occurring by catalyst abrasion from being inpoured into an engine.

### BACKGROUND

Generally, emissions of nitrogen oxide (NOx) may be reduced and a pumping loss may be reduced during intake, by using an external exhaust gas recirculation (EGR) system for a vehicle, thereby obtaining a fuel-efficiency improvement effect.

The EGR system is generally configured to include an EGR inlet pipe, an EGR cooler, an EGR outlet pipe, an EGR valve, and the like. Among those, the EGR inlet pipe is connected to an exhaust pipe which is connected to an exhaust manifold to inpour exhaust gas thereinto and to move the inpoured exhaust gas to the EGR cooler and/or EGR valve side.

FIG. 1 is a diagram illustrating a connection structure between an EGR inlet pipe and an exhaust line. An EGR inlet pipe 103 is connected to an exhaust line 101 to inpour exhaust gas into an engine through the EGR inlet pipe 103.

However, a pipe connection structure inpours a catalyst powder generated from a catalyst into the engine together with the exhaust gas to cause a damage of a cylinder.

That is, the exhaust gas includes combustion gas and various kinds of foreign materials. Among those, when metal oxides (scale, weld spatter, or the like) inpoured into the exhaust manifold are inpoured into an upper end of the catalyst, a carrier is corroded and the catalyst powder is generated.

In this case, the generated catalyst powder is inpoured into the engine through the EGR inlet pipe, and thus, the damage of the cylinder may occur.

The contents described as the related art have been provided only for assisting in the understanding for the background of the present disclosure and should not be considered as corresponding to the related art known to those skilled in the art.

### SUMMARY

An aspect of the present inventive concept provides an apparatus for inpouring exhaust gas by EGR capable of preventing a catalyst powder generated due to catalyst abrasion from being inpoured into an engine.

According to an exemplary embodiment of the present inventive concept, an apparatus for inpouring exhaust gas by EGR includes an EGR line inclined upward, into which the exhaust gas is inpoured, and having a portion of an end thereof connected to a middle portion of the exhaust line.

The EGR line may be connected to a rear end of a catalyst converter which is disposed at the exhaust line.

The EGR line may include an EGR inlet having one end connected to the rear end of the catalyst converter. An EGR pipe is connected between another end of the EGR inlet and an engine.

The EGR inlet may be inclined upward from the one end thereof toward the other end thereof.

The catalyst converter has a front end from which a virtual first central line axially continues toward an inlet side of the EGR inlet such that the virtual first central line intersects with a virtual second central line continued in an axial direction of the EGR inlet at an acute angle

According to another exemplary embodiment of the present inventive concept, an apparatus for inpouring exhaust gas by EGR includes an EGR line connected to a rear end of a catalyst converter which is disposed at an exhaust line and having the exhaust gas inpoured thereinto. An angle has a front end from which a virtual first central line continues toward an inlet side of the EGR inlet such that the virtual first central line intersects with a virtual second central line continued in an axial direction of the EGR inlet is an acute angle.

### BRIEF DESCRIPTION OF THE DRAWINGS

The above and other objects, features and advantages of the present disclosure will be more clearly understood from the following detailed description taken in conjunction with the accompanying drawings.

FIG. 1 is a view for describing a structure of inpouring exhaust gas by an EGR system according to the related art.

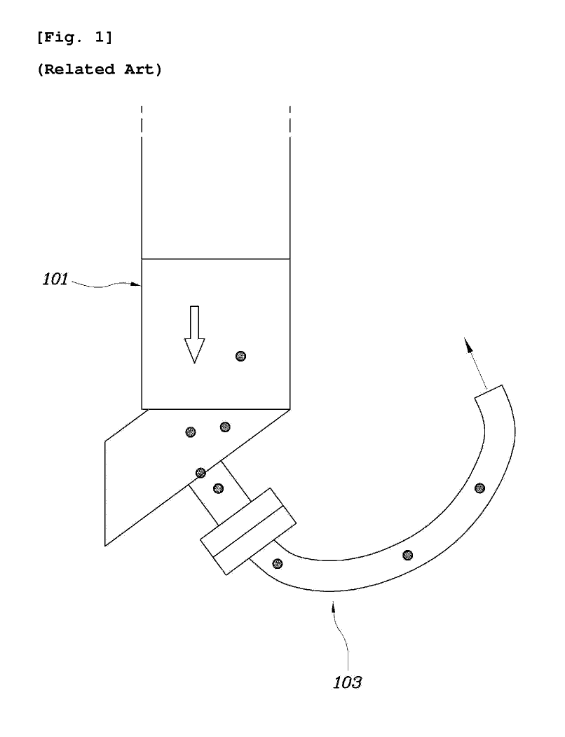

FIG. 2 is a view for describing a structure of inpouring exhaust gas using an apparatus for inpouring exhaust gas by EGR according to an exemplary embodiment of the present inventive concept.

### DETAILED DESCRIPTION

Exemplary embodiments of the present inventive concept will be described in detail with reference to the accompanying drawings.

An apparatus for inpouring exhaust gas by EGR according to an exemplary embodiment of the present inventive concept includes an exhaust line 1 and an EGR line 3.

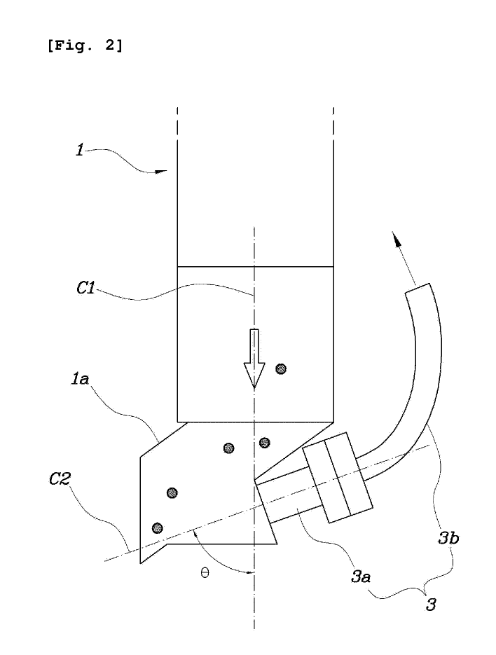

Describing in detail an exemplary embodiment of the present inventive concept with reference to FIG. 2, first, the exhaust line 1 is connected to an exhaust manifold and emits exhaust gas to a muffler side.

Further, the EGR line 3 is connected to a middle portion of the exhaust line 1 and thus is inpoured with the exhaust gas.

In particular, a portion of an end of the EGR line 3 connected to the exhaust line 1 is inclined upward with respect to a virtual horizontal line to inpour some of the exhaust gas emitted through the exhaust line 1 into an engine through the EGR line 3 but prevent foreign materials included in the exhaust gas from being inpoured into the EGR line 3, thereby preventing a risk of a damage of a cylinder due to the inpouring of the foreign materials.

A catalyst converter 1a is disposed on the exhaust line 1, and therefore, the end of the EGR line 3 may be connected to a rear end of the catalyst converter 1a.

That is, even though a catalyst powder is generated due to abrasion of an upper end of a catalyst due to a weld spatter within an exhaust manifold, the inpouring of catalyst powder particle into the engine through the EGR line 3 is prevented, and thus, the damage of the cylinder due to a reflow of the catalyst powder may be radically prevented.

According to an exemplary embodiment of the present inventive concept, the EGR line 3 may include an EGR inlet 3a and an EGR pipe 3b.

In detail, one end of the EGR inlet 3a is connected to the rear end of the catalyst converter 1a, and the EGR pipe 3b is connected between the other end of the EGR inlet 3a and the engine.

In particular, the EGR inlet 3a is inclined upward from one end thereof toward another end thereof to prevent the foreign materials and the catalyst powder from ref lowing through the EGR line 3.

For example, a portion of the rear end of the catalyst converter 1a may protrude toward the EGR inlet 3a, and one end of the EGR inlet 3a may be connected to the protruding portion.

Further, according to the exemplary embodiment of the present inventive concept, a virtual first central line C1 axially continued from a front end of the catalyst converter 1a toward an inlet side of the EGR inlet 3a may be provided, and a virtual second central line C2 continued in an axial direction of the EGR inlet 3a may be provided. In this case, an angle θ formed by intersecting the first central line C1 with the second central line C2 may be an acute angle.

For example, the EGR inlet 3a may be connected to the rear end of the catalyst converter 1a so that the angle θ between the first central line C1 and the second central line C2 is less than 90°.

As described above, according to the exemplary embodiment of the present inventive concept, it is possible to radically prevent the risk of the damage of the cylinder due to the reflow of the foreign materials and the catalyst powder by inpouring some of the exhaust gas emitted through the catalyst converter 1a into the engine through the EGR line 3 but preventing the foreign materials and the catalyst powder included in the exhaust gas from being inpoured into the engine through the EGR line 3, by the EGR inlet 3a connected to the rear end of the catalyst converter la which is inclined upward.

Although specific examples of the present inventive concept have been described above in detail, it is obvious to those skilled in the art that various modifications and alterations may be made without departing from the spirit and scope of the present disclosure. In addition, it is obvious that these modifications and alterations are within the following claims.

What is claimed is:

1. An apparatus for inpouring exhaust gas by exhaust gas recirculation (EGR), comprising:
an EGR line inclined upward, into which the exhaust gas is inpoured, and having a portion of an end thereof connected to a middle portion of the exhaust line.

2. The apparatus of claim 1, wherein the EGR line is connected to a rear end of a catalyst converter which is disposed at the exhaust line.

3. The apparatus of claim 2, wherein the EGR line includes:
an EGR inlet having one end connected to the rear end of the catalyst converter; and
an EGR pipe connected between another end of the EGR inlet and an engine.

4. The apparatus of claim 3, wherein the EGR inlet is inclined upward from the one end thereof toward the other end thereof.

5. The apparatus of claim 4, wherein the catalyst converter has a front end from which a virtual first central line axially continues toward an inlet side of the EGR inlet such that the virtual first central line intersects with a virtual second central line continued in an axial direction of the EGR inlet at an acute angle.

6. An apparatus for inpouring exhaust gas by EGR, comprising:
an EGR line connected to a rear end of a catalyst converter which is disposed at an exhaust line, the EGR line having the exhaust gas inpoured thereinto,
wherein the catalyst converter has a front end from which a virtual first central line continues toward an inlet side of an EGR inlet such that the virtual first central line intersects with a virtual second central line continued in an axial direction of the EGR inlet is an acute angle.

7. The apparatus of claim 3, wherein a portion of the rear end of the catalyst converter protrudes toward the EGR inlet, and the one end of the EGR inlet is connected to the protruding portion.
